(19) United States
(12) Patent Application Publication
(10) Pub. No.: US 2026/0286984 A1
(43) Pub. Date: Sep. 24, 2026

(54) PNEUMATIC CONTROL DEVICE, PROCESS VALVE ASSEMBLY AND PROCESS

(71) Applicant: FESTO SE & CO. KG, Esslingen (DE)

(72) Inventors: Christoph Emilio CORCIONE, Stuttgart (DE); Matthias JOACHIMSTHALER, Karlsruhe (DE)

(21) Appl. No.: 18/881,199

(22) PCT Filed: Jun. 29, 2023
(86) PCT No.: PCT/EP2023/067818

§ 371 Date: Jan. 3, 2025

(30) Foreign Application Priority Data
Jul. 5, 2022 (DE) 10 2022 116 770.4

(51) Int. Cl. F15B 9/09

(52) U.S. Cl. CPC F15B 9/09; F15B 2211/6303; F15B 2211/665

(57) ABSTRACT

A pneumatic control device, in particular a positioner, for controlling a controlled variable to a setpoint value while providing at least one pneumatic control signal. The control device is designed to perform a sliding-mode control with a sliding variable, and, as part of the sliding-mode control, to calculate an actuation signal for actuating a valve device on the basis of a product of an amplification factor and a sign function applied to the sliding variable, in order to provide the at least one pneumatic actuation signal with the valve device.

The invention relates to a pneumatic control device, in particular a positioner, for controlling a controlled variable to a setpoint value while providing at least one pneumatic control signal. The controlled variable is, for example, a position of an actuator member of a pneumatic actuator, for example a process valve with a pneumatic drive and a gate valve. Preferably, the controlled variable is the position of the actuator member of the pneumatic drive with which a valve member of the gate valve is actuated. An arrangement consisting of the control device and the pneumatic actuator is also referred to as an actuator.

When controlling a pneumatic actuator, strong non-linearities generally occur due to the compressibility of the air and due to friction effects, for example in the pneumatic actuator and/or the gate valve. Furthermore, process valves are available in a wide range of variants. The large number of variants and the pronounced non-linearities make it difficult to design a suitable control algorithm that is suitable for many different actuators, in particular for any actuator.

Conventionally, linear controllers such as PID control are used. Linear control approaches can only guarantee high control performance with high robustness to a limited extent. Furthermore, linear controllers require parameterization, for which a (usually) complex identification procedure must be carried out in order to identify the suitable parameter values for the respective actuator.

There are also non-linear approaches for controlling pneumatic actuators. Non-linear approaches generally enable a shorter settling time with a simultaneous improvement in control quality and greater robustness against disturbance. However, these methods are significantly more complex than linear control approaches. As a rule, non-linear approaches require a high degree of model knowledge about the system to be controlled. This is generally not the case in the process industry. On the one hand, the number of variants is too high, and on the other hand, the available sensor technology for automatic identification to obtain sufficient model quality is limited.

Sliding mode control, which can also be referred to as sliding mode regulation, is known from research. In sliding mode control, a sliding variable σ(x) is defined, which dependents on the states x of the system to be controlled. The control objective of a sliding mode controller is to control the sliding variable to zero in a finite time.

Huang, Kuo, Chang: “Adaptive Sliding-Mode Control for Nonlinear Systems With Uncertain Parameters”, IEEE TRANSACTIONS ON SYSTEMS, MAN, AND CYBERNETICS-PART B: CYBERNETICS, VOL. 38, NO. 2, APRIL 2008, presents a method in which an amplification factor increases continuously as long as the sliding plane is not reached.

Fang, Tsai, Yan, Guo: “Adaptive Chattering-Free Sliding Mode Control of Chaotic Systems with Unknown Input Nonlinearity via Smooth Hyperbolic Tangent Function”, Mathematical Problems in Engineering, 2019, describes an adaptation algorithm that depends on the magnitude of the sliding variable.

Plestan, Shtessel, Brégeault, Poznyak: “New methodologies for adaptive sliding mode control”, International Journal of Control, Volume 83, July 2010, describes a method in which is the mean manipulated variable is approximated in the vicinity of the sliding plane. Furthermore, a method is described in which the amplification is varied dynamically in order to find the smallest permissible value for the amplification factor.

Edwards, Shtessel: “Adaptive continuous higher order Sliding mode control”, Automatica 65, 2016, describes an adaptation strategy that is not dependent on the sliding variable.

Kuo, Huang, Chang: “Sliding mode control with self-tuning law for uncertain nonlinear systems”, ISA Transactions 47, 2008, replaces a discontinuous sign function with a continuous saturation function whose slope is adapted to a process in an environment around zero.

Ertugrul, Kerestiecioglu, Kaynak: “Gain adaptation in sliding mode control of robotic manipulators”, International Journal of Systems Science 31, September 2000, describes a combination of an approximation of a mean controller signal using a low-pass filter with an adaptive amplification factor.

Hall, Shtessel: “Sliding mode disturbance observer-based control for a reusable launch vehicle”, AIAA J. Guidance, Control, and Dynamics 29, 2006, describes the use of an observer for the uncertainties of the system to adapt the amplification factor.

Furthermore, a super-twisting algorithm is known—a second-order sliding-mode controller that depends only on the sliding variable. The following publications describe adaptive variations of a super-twisting algorithm: Davila, Moreno, Fridman: “Variable Gains Super-Twisting Algorithm: A Lyapunov Based Design”, American Control Conference, 2010; Shtessel, Moreno, Plestan, Fridman, Poznyak: “Super-twisting Adaptive Sliding Mode Control: a Lyapunov Design”, 49th IEEE Conference on Decision and Control, December 2010; Utkin, Poznyak: “Adaptive Sliding mode control with application to super-twist algorithm: Equivalent control method”, Automatica 49, 2013.

One task of the invention is to provide a control device that can be used in a simple and flexible manner.

The problem is solved by a control device according to claim 1. The control device is designed to perform a sliding-mode control with a sliding variable and, as part of the sliding-mode control, to calculate an actuation signal for actuating a valve device on the basis of a product of an amplification factor and a sign function applied to the sliding variable, in order to provide the at least one pneumatic actuation signal with the valve device.

It has been found that sliding mode control is particularly suitable for use in a pneumatic control device, such as a positioner. The sliding mode control can be used for a large number of different actuator variants without having to adapt the sliding mode control to the respective variant. The control device can therefore be used in a simple and flexible manner. Ideally, the sliding mode control is carried out without an identification procedure (in particular outside and/or before operation) for the identification of controller parameters. Furthermore, the sliding mode control preferably does not require any expertise from the customer in order to specify any restrictions.

Advantageous further developments are the subject of the dependent claims.

The invention also relates to a process valve assembly comprising a positioner which is designed in accordance with the pneumatic control device, and a process valve with an actuator and a gate valve, wherein the positioner is designed to carry out a control of the process valve.

The invention further relates to a method for operating the pneumatic control device, comprising the step of: calculating the actuation signal based on the product of the amplification factor and the sign function.

Further exemplary details and exemplary embodiments are explained below with reference to the figures. It shows

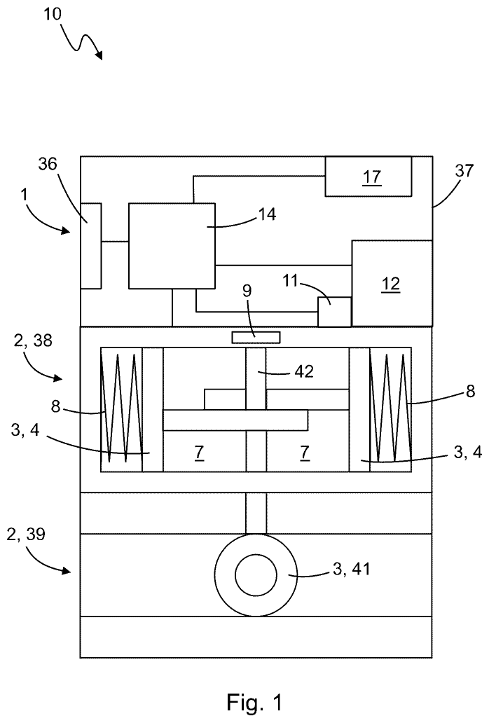

FIG. 1 a schematic view of an arrangement with a pneumatic control device and a pneumatic actuator,

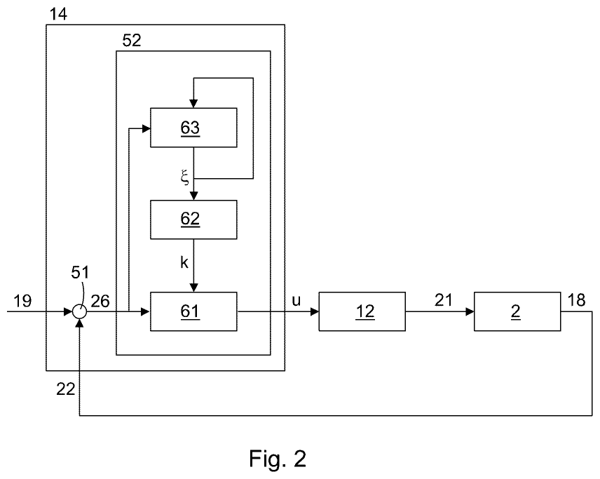

FIG. 2 a block diagram of a control,

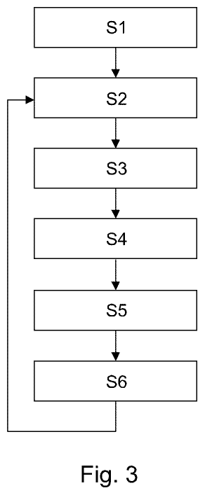

FIG. 3 a method for calculating an actuation signal.

FIG. 1 shows an arrangement 10 comprising a pneumatic control device 1 and a pneumatic actuator 2. The arrangement 10 represents an exemplary application environment for the pneumatic control device 1. The control device 1 can also be provided on its own—i.e., in particular without the pneumatic actuator 2.

As an example, the arrangement 10 is designed as an actuator, in particular as a process valve unit. The control device 1 is exemplarily designed as a positioner and can also be referred to as a position regulator. The pneumatic actuator is exemplarily designed as a process valve. The process valve unit is used to control or regulate a fluid flow in a process complex.

First to the control device 1:

The control device 1 is designed for use in industrial automation, in particular in process automation. The control device 1 is designed to control the pneumatic actuator 2.

Preferably, the control device 1 has a valve device 12, by means of which the control device 1 can ventilate and/or bleed a first pressure chamber 7 of the pneumatic actuator 2. The valve device 12 is designed, for example, as an electropneumatic transducer. The valve device 12 advantageously has one or more pilot valves.

Optionally, the control device 1 has an input unit 17 by means of which a user can make an input into the control device 1.

Preferably, the control device 1 has a control unit 14, which is designed as a microcontroller, for example. Preferably, the control unit 14 controls the valve device 12.

Optionally, the control device 1 has a communication interface 36, which is used in particular for communication with a higher-level control system, for example to receive a setpoint value 19, in particular for controlling the position of an actuator member 3 of the pneumatic actuator 2. Advantageously, the communication interface 36 makes the setpoint value 19 available to the control unit 14.

The control device 1 advantageously comprises a housing 37, in which the valve device 12, the control unit 14 and/or a pressure sensor device 11 are preferably arranged. By way of example, the input unit 17 and/or the communication interface 36 are arranged in and/or on the housing 37.

The control device 1 (designed in particular as a positioner) is attached to the pneumatic actuator 2 by way of example, in particular with its housing 37.

Now to the pneumatic actuator 2:

The pneumatic actuator 2 conveniently comprises a pneumatic drive 38 and a gate valve 39 that can be actuated by the pneumatic drive 38. The gate valve 39 is in particular a process gate valve.

The pneumatic actuator 2, in particular the drive 38, has an actuator member 3. The pneumatic actuator 2, in particular the drive 38, has a piston arrangement 4. As an example, the piston arrangement 4 forms the actuator member 3. The pneumatic actuator 2, in particular the actuator 38, features the first pressure chamber 7. The first pressure chamber 7 is limited by the piston arrangement 4. The position of the actuator member 3 can be changed by applying compressed air to the first pressure chamber 7. By way of example only, the pneumatic actuator 2 is designed as a single-acting actuator. The pneumatic actuator 2, in particular the drive 38, comprises a spring element 8, which provides a spring force acting on the piston arrangement 4.

Alternatively, the pneumatic actuator 2, in particular the drive 38, can be designed as a double-acting actuator.

The drive 38 is designed as a rotary drive, for example. As an example, the drive 38 is designed as a piston actuator. Alternatively, the drive 38 can be designed as a diaphragm actuator. The gate valve 39 comprises a valve member 41, which is actuated via the drive 38. The gate valve 39 can, for example, be designed as a flap, slide valve or ball valve. The drive 38 has a drive element 42 that can be driven via the piston arrangement 4. The drive element 42 is coupled to the valve member 41 so that the position of the valve member 41 can be changed via the drive element 42. Advantageously, the piston arrangement 4, the drive element 42 or the valve member 41 represents the actuator member 3.

As an example, the arrangement 10 has a sensor device which advantageously comprises a pressure sensor device 11 and/or a position sensor device 9. The sensor device, in particular the pressure sensor device 11 and/or the position sensor device 9, is designed to detect a controlled variable 18 to be controlled by the control device 1 and to provide it as a feedback variable 22 (in particular to the control unit 14).

The pressure sensor device 11 may be a part of the control device 1. The pressure sensor device 11 is preferably used to detect a current pressure of the first pressure chamber 7.

The position sensor device 9 is arranged on the pneumatic actuator 2 as an example. The position sensor device 9 is used to detect the current position of the actuator member 3. Conveniently, the position sensor device 9 can be used to detect the current position of the actuator member 3 over the entire movement path of the actuator member 3—i.e., from a first end position to a second end position.

The control performed by the pneumatic control device 1 is described in more detail below. FIG. 2 shows a block diagram of an exemplary implementation of this control.

The pneumatic control device 1 is used to control the controlled variable 18 to the setpoint value 19 by providing at least one pneumatic control signal 21. As an example, the controlled variable 18 is a position of the actuator member 3. Furthermore, the controlled variable 18 can be a pressure, for example the pressure of the first pressure chamber 7, a flow rate, for example a flow rate through the gate valve 39, a fill level or a force. The setpoint value 19 is provided, for example, by the higher-level control system and transmitted to the control device 1. Furthermore, the setpoint value 19 can be provided, for example calculated, by the control device 1. The pneumatic control signal 21 is output by the valve device 12, for example into the first pressure chamber 7.

As an example, the control is carried out by means of the control unit 14. Conveniently, the control unit 14 comprises a subtraction element 51 and/or a regulator unit 52 designed, for example, as a controller algorithm. The subtraction element 51 calculates a control deviation 26 as the difference between the setpoint value 19 and the feedback variable 22. The controller unit 52 calculates an actuation signal u on the basis of the control deviation 26, the valve device 12 is actuated with the actuation signal u. The valve device 12 outputs the at least one pneumatic control signal 21 in accordance with the actuation signal u, in particular to the pneumatic actuator 2, in order to cause the controlled variable 18 to change towards the setpoint value 19. The current value of the controlled variable 18 is fed back as feedback variable 22.

The control device 1 is designed to perform a sliding mode control with a sliding variable σ(x). The sliding mode control can also be referred to as sliding mode regulation. The sliding variable can also be referred to as a sliding mode variable. The sliding variable σ(x) is dependent on one or more states x of the system to be controlled. For example, the sliding variable σ(x) is defined as the difference between the setpoint value 19 and the controlled variable 18. The sliding variable is advantageously equal to the control deviation 26. The sliding variable is also referred to below as a in the following.

The subspace bounded by the condition σ(x)=0 is called the sliding plane. If the system moves on this sliding plane, its dynamics are unaffected by disturbances or parameter inaccuracies. Since the sliding variable can be specified, the dynamics can also be specified on the sliding plane. This means that the system is asymptotically stable and converges as soon as σ(x)=0 applies. The control objective of sliding mode control is to control the sliding variable to zero in a finite time.

The control device 1 is designed to calculate the actuation signal u for actuating the valve device 12 as part of the sliding mode control on the basis of a product of an amplification factor k and a sign function applied to the sliding variable, in order to provide the at least one pneumatic control signal 21 with the valve device 12. The actuation signal u is, for example, an electrical actuation signal and is output by the control unit 14 to the valve device 12 in order to control the output of the pneumatic control signal 21.

As an example, the control device 1 is designed to calculate the actuation signal u according to the following equation (1):

$$u = - k sign ( σ ) \qquad ( 1 )$$

In equation (1), “u” is the actuation signal, “k” is the amplification factor and sign(σ) is the sign function applied to the sliding variable σ. The amplification factor k is preferably positive.

The control device 1 is advantageously designed to control the sliding variable a to zero, in particular on the basis of equation (1), which is suitably a discontinuous control law.

As an example, the regulator unit 52 comprises an actuation signal calculation element 61 which is designed to calculate the actuation signal u on the basis of the control deviation 26 and the amplification factor k, in particular according to equation (1).

Preferably, the pneumatic control device 1 is designed to adapt the amplification factor k during sliding mode control. Such sliding mode control, in which the amplification factor k is adapted, is also referred to as adaptive sliding mode control. Preferably, the pneumatic control device 1 is designed to continuously adapt the amplification factor k. In particular, the pneumatic control device 1 is designed to perform a respective calculation of a value of the amplification factor k for each calculation of a value of the actuation signal u in order to calculate the value of the actuation signal u using this value of the amplification factor k.

In an exemplary embodiment, the regulator unit 52 comprises an amplification factor calculation element 62 which is configured to adjust the amplification factor k, in particular continuously. Advantageously, the amplification factor calculation element 62 is designed to calculate, in particular to adjust, the amplification factor k on the basis of a substitution variable ξ.

By adjusting the amplification factor k, the control can be quickly adapted to changes without risking the stability of the control. For example, by adjusting the amplification factor k, it is possible in particular to prevent disturbances in the controlled variable 18 from being insufficiently compensated (due to an amplification factor k that is too small) and/or to prevent chattering (due to an amplification factor k that is too large), i.e., uncontrolled overshooting of the controlled variable 18. In particular, the control device 1 is designed to vary the amplification factor k during operation in such a way that disturbances and/or inaccuracies are compensated for, but the amplification factor k is not overestimated.

Preferably, the pneumatic control device 1 is designed to calculate the amplification factor k on the basis of a square of the substitution variable ξ. For example, the pneumatic control device 1 is designed to calculate the amplification factor k according to the following equation (2):

$$k = \frac{1}{2} {ξ}^{2} \qquad ( 2 )$$

In equation (2) F is the substitution variable.

Due to this use of the substitution variable ξ, it can be guaranteed that the amplification factor k remains positive at all times. No lower bound for the amplification factor k needs to be introduced for this. Advantageously, no lower bound is defined for the amplification factor k.

Furthermore, the pneumatic control device 1 can be designed to calculate the amplification factor k as the product of the square of the substitution variable ξ and a power rate factor. The power rate factor is in particular the amount of the sliding variable σ to the power of an exponent α which is advantageously between 0 and 1. For example, the pneumatic control device 1 is designed to calculate the amplification factor k according to the following equation (3):

$$k = \frac{1}{2} {ξ}^{2} {\vert σ \vert}^{α} \qquad ( 3 )$$

The exponent α is used to heuristically influence the speed/aggressiveness of the controller.

As an example, the amplification factor calculation element 62 is configured to calculate the amplification factor k according to equation (2) or equation (3).

Preferably, the pneumatic control device 1 is designed to perform a minimization of an objective function in order to calculate the amplification factor k. Preferably, the objective function depends on the sliding variable and/or the actuation signal u, so that the minimization of the objective function minimizes the sliding variable and/or the actuation signal u. In particular, the objective function is defined in such a way that the minimization—in particular by adjusting the substitution variable ξ—a square distance to the sliding plane—i.e., the square of the sliding variable as an example—and the square of the actuation signal u are minimized at the same time. The square of the actuation signal u represents a measure of the energy of the input that is to be minimized. The minimization of the objective function is advantageously an optimization problem; the minimization of the objective function is also referred to below as an optimization problem.

For example, the aforementioned minimization is the minimization defined in equation (4):

$${min}_{ξ} J = \frac{1}{2} ( {Γ}^{- 1} {σ}^{2} + {u}^{2} ) \qquad ( 4 )$$

The objective function to be minimized is

$$J = \frac{1}{2} ( {Γ}^{- 1} {σ}^{2} + {u}^{2} ) .$$

The objective function to be minimized comprises, by way of example, a sum of the square of the substitution variable σ (exemplarily multiplied by a penalty factor Γ⁻¹) and the square of the actuation signal u. The penalty factor Γ⁻¹ describes an (in particular unknown) inverse input uncertainty and results from a mathematical modeling of uncertain systems. Advantageously, the penalty factor Γ⁻¹ reduces a non-inverse input uncertainty in the dynamic solution of the optimization problem discussed below.

As already mentioned above, the pneumatic control device 1 is designed to calculate the amplification factor k on the basis of the substitution variable ξ Preferably, the pneumatic control device 1 is designed to use the substitution variable ξ as a variable of the objective function. The pneumatic control device 1 is advantageously designed to adjust the substitution variable ξ as part of the minimization of the objective function—i.e., to solve the optimization problem—so that the objective function is minimized.

Preferably, the pneumatic control device 1 is designed to solve the optimization problem—i.e., the minimization of the objective function—numerically, in particular on the basis of the gradient descent method. In particular, the pneumatic control device 1 is designed to solve the optimization problem dynamically so that the objective function converges towards a minimum. For example, the pneumatic control device 1 is designed to solve the optimization problem according to the following equation (5):

$$\frac{\partial ξ}{\partial t} = - γ \frac{\partial J}{\partial ξ} \qquad ( 5 )$$

Alternatively, the pneumatic control device 1 can be designed to solve the optimization problem using a different method, in particular a different numerical method, for example using the momentum gradient descent algorithm.

By calculating the partial derivatives, the following control law described by equations (6) and (7) is advantageously obtained. The pneumatic control device 1 is preferably designed to calculate the actuation signal u on the basis of the control deviation 26 in accordance with this control law—i.e., in accordance with equations (6) and (7).

$$u = - \frac{1}{2} {ξ}^{2} {\vert σ \vert}^{α} sign ( σ ( x ) ) \qquad ( 6 )$$

$$\frac{\partial ξ}{\partial t} = γ [ σ \int ξ {\vert σ \vert}^{α} sign ( σ ) d τ - \frac{1}{2} {ξ}^{3} {\vert σ \vert}^{α} ] \qquad ( 7 )$$

γ is a step size factor and, in particular, a heuristic parameter. The step size factor γ determines the speed of the algorithm, i.e., in particular the speed of the adaptation of ξ. The exponent α is advantageously a heuristic parameter. With the parameters α and γ the aggressiveness of the controller and/or the aggressiveness of the adaptation of ξ—and thus the adaptation of the amplification factor k—can be adjusted. Preferably, the control device 1 is designed to set the parameters α and γ automatically. Furthermore, the parameters α and γ can be entered into the control device 1, for example via the input unit 17 and/or via the communication interface 36.

The power rate factor |σ|^{α} is advantageously optional, in particular in equation (6) and or equation (7). The pneumatic control device 1 can be designed to calculate the substitution variable ξ according to the following equation (8) (in particular as an alternative to equation (7)):

$$\frac{\partial ξ}{\partial t} = γ [ σ \int ξ sign ( σ ) d τ - \frac{1}{2} {ξ}^{3} ] \qquad ( 8 )$$

Advantageously, the controller unit 52 comprises a substitution variable calculation element 63, which is designed to calculate the substitution variable ξ in particular in the context of the above-described minimization of the objective function and/or according to equation (7) or (8).

In particular, the pneumatic control device 1 is designed to perform a respective calculation of a value of the substitution variable for each calculation of a value of the actuation signal u to calculate the value of the substitution variable ξ on the basis of this calculated value of the amplification factor ξ (in particular via the amplification factor k) to calculate the value of the actuation signal u.

The pneumatic control device 1 is preferably designed to calculate the amplification factor k on the basis of the substitution variables ξ and to calculate a current value of the substitution variable ξ on the basis of a previous value of the substitution variable ξ. In particular, each current value of the substitution variable ξ is calculated in this way—namely on the basis of the respective previous value of the substitution variable ξ. Advantageously, the control device 1 performs an iterative adjustment of the substitution variables ξ in particular continuously, and preferably for the purpose of minimizing the objective function.

As an example, the output—i.e., the calculated substitution variable ξ—of the substitution variable calculation element 63 is fed back to an input of the substitution variable calculation element 63 in order to be used for the calculation of the next value of the substitution variable ξ.

For example, the substitution variable calculation element 63 calculates the respective current value of the substitution variable ξ (on the basis of which the amplification factor k for calculating the actuation signal u is calculated) on the basis of the respective previously calculated value of the substitution variable ξ and equation (7) (or alternatively equation (8)). For example, the substitution variable calculation element 63 inserts the previously calculated value of the substitution variable ξ into the equation (7) (or alternatively the equation (8)) in order to calculate

$$\frac{\partial ξ}{\partial t} .$$

For example, the substitution variable calculation element 63 calculates the current value of the substitution variable ξ on the basis of

$$\frac{\partial ξ}{\partial t}$$

in particular by adding

$$\frac{\partial ξ}{\partial t}$$

to the previously calculated value of the substitution variable ξ.

Preferably, the pneumatic control device 1 is designed to calculate the current value of the substitution variable ξ on the basis of the previous value of the substitution variable ξ and on the basis of the sliding variable σ—i.e., exemplarily on the basis of the control deviation 26. As shown in FIG. 2, the control deviation 26 is fed to the substitution variable calculation element 63 and the substitution variable calculation element 63 calculates the current value of the substitution variable ξ based on the control deviation 26 on the basis of the control deviation 26, in particular using equation (7) or equation (8).

As mentioned above, it is advantageously to adjust the substitution variables iteratively ξ.

The pneumatic control device 1 is advantageously designed to perform a plurality of iteration steps to minimize the objective function and to calculate a respective current value of the substitution variable ξ in each iteration step, in particular in such a way that each iteration step is aimed at minimizing the objective function (in particular in the sense of a further reduction of the objective function compared to the respective previous iteration step).

Advantageously, the pneumatic control device 1 is designed to calculate in each iteration step a respective current value of the substitution variable ξ on the basis of a value of the substitution variable ξ calculated in a respective previous iteration step and on the basis of a change in the substitution variable ξ calculated in particular for the purpose of minimizing the objective function, for example, as the sum of the value of the substitution variable ξ calculated in the previous iteration step and the change in the substitution variable ξ. The change is, for example

$$\frac{\partial ξ}{\partial t}$$

from equation (7) or equation (8). The pneumatic control device 1 is designed to calculate the change (of the substitution variable ξ) on the basis of the sliding variable σ and/or on the basis of the substitution variable ξ in particular according to equation (7) or equation (8).

The pneumatic control device 1 is advantageously designed to calculate a current value of the actuation signal u in each iteration step on the basis of the current value of the substitution variable ξ calculated in the respective iteration step and to control the valve device 12 using the actuation signal u. The pneumatic control device 1 is advantageously designed to calculate the control deviation 26 resulting from this actuation and, in a respective next iteration step, to calculate a respective next current value of the substitution variable ξ on the basis of the control deviation 26, in particular in accordance with equation (1) on the basis of equation (7) or equation (8).

By way of example, the iterative adjustment of the substitution variables ξ can result in a temporal progression of the amplification factor k (calculated on the basis of the substitution variables ξ), in which the amplification factor is initially increased until the amplification factor k reaches a threshold value that is large enough to compensate for uncertainties in the system and to converge towards the sliding plane. As the system now converges towards the sliding plane, the adaptive dynamics reduces more and more to a differential equation converging towards zero. This means that the amplification factor k decreases again. If it falls below the threshold value again, it starts to rise again and so on. This results in the amplification factor k converging towards this threshold value. Advantageously, the threshold value represents a solution to the optimization problem; for example, the threshold value represents the smallest permissible value for the amplification factor k—i.e., in particular a smallest value from which no further reduction of the amplification factor k takes place. If disturbances/parameters of the system change, the threshold value changes and the threshold value converges towards this new threshold value.

With reference to FIG. 3, a method for iteratively adjusting the substitution variable ξ (in order to thereby adjust the amplification factor k), which is carried out in particular by the control device 1, is described below.

The method comprises an optional first step S1 in which a first value for the actuation signal u is obtained, for example by setting an initial value for the substitution variable ξ or the amplification factor k, and the first value for the actuation signal u is calculated based thereon, or by setting an initial value as the first value for the actuation signal u.

The method comprises a second step S2, in which the valve device 12 is actuated with the first value of the actuation signal u so that it provides the pneumatic control signal 21 in accordance with the actuation signal u in order to influence the controlled variable 18.

The method comprises a third step S3, in which a current value of the sliding variable σ is calculated on the basis of the influenced controlled variable 18—i.e., the control deviation 26, is calculated as an example.

The method comprises a fourth step S4, in which, on the basis of the current value of the sliding variable σ calculated in step S3 a current value of the substitution variable ξ is calculated, in particular on the basis of a previously obtained value (for example an initial value) of the substitution variable ξ and preferably using equation (7) or (8).

The method comprises a fifth step S5 in which, on the basis of the substitution variable ξ calculated in step S4 a current value of the amplification factor k is calculated, in particular on the basis of equation (2) or (3).

The method comprises a sixth step S6, in which a current value of the actuation signal u is calculated on the basis of the amplification factor k calculated in step S5, in particular on the basis of equation (1).

The method then returns to step S2 and performs the actuation of the valve device 12 with the current value of the actuation signal u calculated in step S6, so that it provides the pneumatic control signal 21 in accordance with the actuation signal u in order to influence the controlled variable 18.

The method continues with steps S3, S4, S5 and S6, wherein in step S4 the current value of the substitution variable ξ is calculated on the basis of the value of the substitution variable ξ calculated in the previously performed step S4.

Steps S2 to S6 are repeated continuously in order to carry out the control of the controlled variable 18 and, in the meantime, to continuously adjust the substitution variable ξ (and thereby the amplification factor k) continuously, in particular in such a way that the objective function is minimized. An execution of steps S2 to S6 advantageously represents an iteration step explained above.

Preferably, the pneumatic control device 1 is designed to perform a diagnosis based on the amplification factor k and/or the substitution variable ξ. Preferably, the pneumatic control device 1 is designed to provide a diagnostic function based on a change in the amplification factor k and/or the substitution variable ξ and, advantageously, taking into account the actuation signal u, for example to detect a leakage or increased friction of the actuator 2, in particular without this being apparent in the position or control. The diagnostic function advantageously includes the provision of a warning to a user.

For example, the pneumatic control device 1 is designed to detect a leakage on the basis of an increase in the amplification factor k and/or an offset of the actuation signal u (for example compared to a stored reference actuation signal) and optionally to quantify the size of the leakage.

Optionally, the controller unit 52 is designed as a higher-order sliding-mode controller that acts on a higher derivative of the sliding variable. Advantageously, such a higher-order sliding mode controller is designed to calculate the actuation signal u on the basis of the sliding variable, one or more of its derivatives and an amplification factor. Optionally, the controller unit 52 may further comprise a super-twisting algorithm.

1. A pneumatic control device for controlling a controlled variable to a setpoint value while providing at least one pneumatic control signal, the control device being designed to perform a sliding-mode control with a sliding variable, and, as part of the sliding-mode control, to calculate an actuation signal for actuating a valve device on the basis of a product of an amplification factor and a sign function applied to the sliding variable, in order to provide the at least one pneumatic actuation signal with the valve device.

2. The pneumatic control device according to claim 1, wherein the pneumatic control device is designed to adjust the amplification factor during the sliding mode control.

3. The pneumatic control device according to claim 1, wherein the pneumatic control device is designed to continuously adjust the amplification factor.

4. The pneumatic control device according to claim 1, wherein the pneumatic control device is designed to calculate the amplification factor on the basis of a square of a substitution variable.

5. The pneumatic control device according to claim 1, wherein the pneumatic control device is adapted to calculate the amplification factor on the basis of a substitution variable(s), and to calculate a current value of the substitution variable on the basis of a previous value of the substitution variable.

6. The pneumatic control device according to claim 5, wherein the pneumatic control device is designed to determine the current value of the substitution variable on the basis of the previous value of the substitution variable and on the basis of the sliding variable.

7. The pneumatic control device according to claim 1, wherein the pneumatic control device is designed to perform a minimization of an objective function in order to calculate the amplification factor.

8. The pneumatic control device according to claim 7, wherein the objective function depends on the sliding variable and/or the actuation signal, so that the minimization of the objective function minimizes the sliding variable and/or the actuation signal.

9. The pneumatic control device according to claim 7, wherein the pneumatic control device is designed to calculate the amplification factor on the basis of a substitution variable and to use the substitution variable as variable of the objective function.

10. The pneumatic control device according to claim 9, wherein the pneumatic control device is designed to perform a plurality of iteration steps to minimize the objective function and to calculate a respective current value of the substitution variable in each iteration step.

11. The pneumatic control device according to claim 10, wherein the pneumatic control device is designed to calculate a respective current value of the actuation signal in each iteration step on the basis of the respective current value of the substitution variable calculated in the respective iteration step and to control the valve device using the actuation signal.

12. The pneumatic control device according to claim 1, wherein the pneumatic control device is designed to perform a diagnosis on the basis of the amplification factor and/or a/the substitution variable, on which the amplification factor is based.

13. A process valve assembly, comprising a positioner which is designed in accordance with a control device according to claim 1, and a process valve with an actuator and a gate valve, wherein the positioner is designed to carry out a control of the process valve.

14. A method for operating a pneumatic control device according to claim 1, comprising the step of: calculating the actuation signal based on the product of the amplification factor and the sign function.
